(19) United States
(12) Patent Application Publication
(10) Pub. No.: US 2015/0307197 A1
(43) Pub. Date: Oct. 29, 2015

(54) Multi-Use Emergency Descent Device

(71) Applicant: Capewell Systems LLC, South Windsor, CT (US)

(72) Inventor: Dean A. Sienna, Wethersfield, CT (US)

(21) Appl. No.: 14/676,869

(22) Filed: Apr. 2, 2015

Related U.S. Application Data
(60) Provisional application No. 61/984,936, filed on Apr. 28, 2014.

(51) Int. Cl. B64D 25/08

(52) U.S. Cl. CPC B64D 25/08

(57) ABSTRACT

A multi-use emergency descent device for descent of a payload from an aircraft has a tape assembly in operative communication with a braking assembly and return assembly. The tape assembly has a tape wound about an axis. The braking assembly causes deceleration of the tape during unwinding and the return assembly when activated initiates retraction of the tape.

### CROSS-REFERENCE TO RELATED APPLICATION

This application claims priority to U.S. Provisional Patent Application No. 61/984,936, for Multi-Use Emergency Descent Device, filed Apr. 28, 2014, the entire disclosure of which is hereby incorporated by reference.

### BACKGROUND OF THE DISCLOSURE

The present disclosure relates to descent devices, and more particularly, to reusable emergency descent devices.

Numerous descent assistance devices have been developed for aiding in the lowering of a load from a higher to a lower elevation. Several known emergency descent devices (EDD) are designed specifically for use in aircraft for providing a safe and rapid evacuation during an on-ground emergency situation requiring aircrew egress. EDDs have been developed to be simpler and quicker than descending a rope or rope ladder, and allow an individual to effortlessly descend in seconds from the escape hatch of a variety of commercial aircraft.

Prior art EDDs typically include a body having a handle at one end, and an extensible tape which may comprise a cord, rope or cable and a centrifugal braking system. During use, an individual attaches the extensible tape to an anchor point, grasps the handle, exits an escape hatch or similar portal on the aircraft, and descends with the EDD to the ground. As the individual approaches the ground, a centrifugal breaking system reduces the rate of descent to a safe level, allowing a rapid descent while limiting any potential injury risk.

Such known EDDs require significant grip strength and are configured for a single use. Once an individual descends to the ground via an EDD, the EDD must be returned to the manufacturer to be rebuilt according to specific FAA safety regulations. Therefore, it is necessary to stock one EDD for each aircrew member in the event of an emergency, as well as purchase and stock numerous backup or replacement EEDs.

Accordingly, there is a need for an improved emergency descent device that allows repeat evacuation from an aircraft cockpit in an emergency.

### SUMMARY

A multi-use EED for decent of a payload from an aircraft has a tape assembly, braking assembly and return assembly in operative communication with each other. The tape assembly has a first end connected to a spool around which the tape is wound. The braking assembly causes deceleration of the tape being unwound from the spool during descent of a payload, and the return assembly initiates retraction of the tape once activated.

In another embodiment, a multi-use EED has a tape assembly with a retractable tape having a first end connected to a spool defining an axis of rotation around which the tape is wound. A terminal end of the tape is attachable to a payload and reciprocable between a retracted position and an extended position. A braking assembly is operatively associated with the tape assembly for retarding the rate of unwinding of the tape from the retracted position to the extended position. A return assembly is operatively associated with the tape assembly for re-winding the tape from the extended position to the retracted position when activated.

### BRIEF DESCRIPTION OF THE DRAWINGS

Aspects of the preferred embodiment will be described in reference to the drawings, where like numerals reflect like elements throughout:

FIG. 1 shows a perspective view, partly in phantom, of an embodiment of the disclosed multi-use EDD;

FIG. 2 shows a perspective view, partly in phantom, of a brake section of the multi-use EDD of FIG. 1;

FIG. 3 shows a perspective view of the multi-use EDD of FIG. 1 showing the extensible tape section, with the brake section omitted for clarity; and

FIG. 4 shows a perspective view of the return spring section of the multi-use EDD of FIG. 1, with the brake section and extensible tape section omitted for clarity.

### DETAILED DESCRIPTION OF THE PREFERRED EMBODIMENT

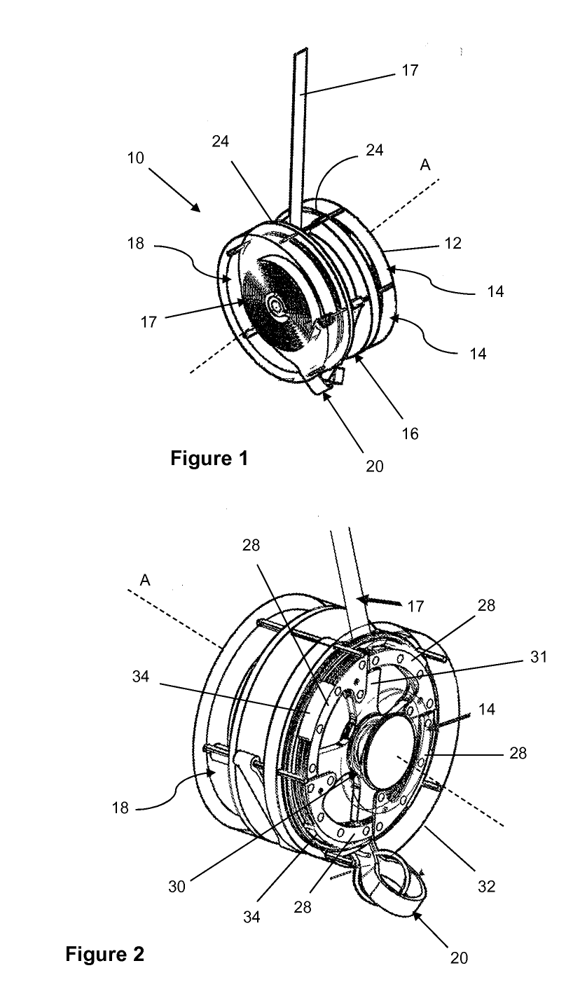

Embodiments of a multi-use EDD 10 will now be described with reference to the Figures, wherein like numerals represent like parts throughout FIGS. 1-4.

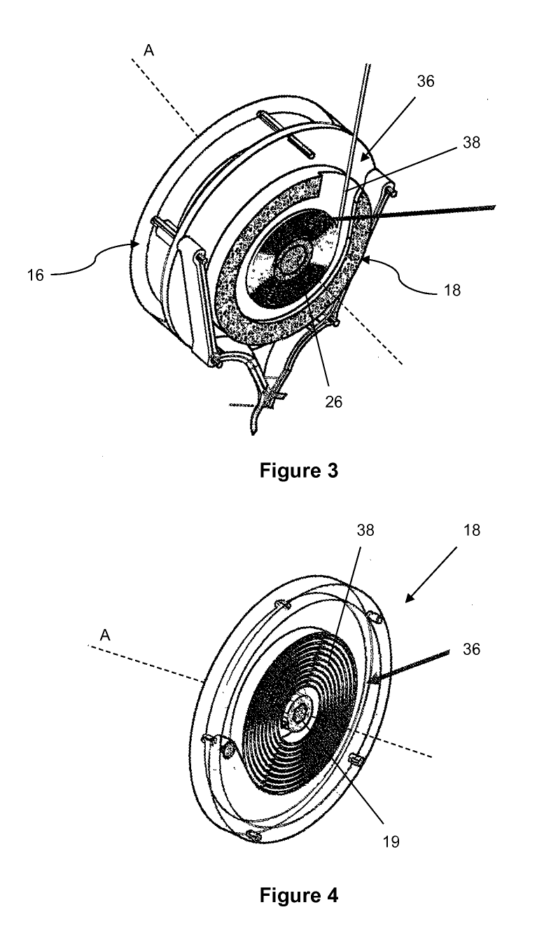

As seen in FIG. 1, a multi-use EDD 10 includes a housing 12 enclosing an operatively associated braking assembly 14, extensible tape assembly 16, and return member assembly 18. As shown, a handle or loop 20 projects from an opening in the housing. As best seen in FIG. 3, an axle 26 defining a substantially central axis A extends through the housing 12 and operatively connects the braking assembly 14, tape assembly 16 and return member assembly 18. In this embodiment, the braking assembly 14, extensible tape assembly 16 and return member assembly 18 are arranged about the axis A in a substantially parallel relationship to each other, and are separated by sectional walls 24.

Referring to FIG. 2, the braking assembly 14 comprises a centrifugal brake with a plurality of brake arms 28. Each brake arm 28 is generally arcuately shaped and pivotally connected to one of a plurality of spokes 31 radially beyond a brake hub 30. In the disclosed embodiment, a freewheel or one-way clutch member (not shown) may connect the hub 30 and the axle 26. The freewheel provides a connection between the braking assembly 14, the extensible tape assembly 16 and return member assembly 18 during rotation in only a single direction for reducing parasitic drag from the braking assembly 14 once the device 10 is released after descent. The braking assembly 14 also includes an outer drum 32 (shown in phantom) enclosing the brake arms 28 and other operative elements.

The tape assembly 16 includes a tape 17 attached to and wound about a spool 19 coaxial with axis A in the initial retracted position. Descent of an individual causes an unwinding of the tape 17 from the spool 19 and connective/cooperative rotation of the braking assembly 14 about axis A. The resulting centrifugal forces from rotation of the brake assembly 14 urge the brake arms 28 to pivot outwardly at each point of connection with the spokes 32. The brake arms 28 may include pads 34 configured to engage the drum 32, thereby providing a frictional braking force against the drum 32. Once the velocity of decent reaches a predetermined level (i.e., “terminal descent velocity”), centrifugal force exerted by the hub assembly forces the pads 34 against the drum 32 sufficiently for the frictional braking force to counteract the gravity-induced acceleration of the descending individual. The frictional force at terminal descent velocity reaches a steady state, and the brake assembly 14 decelerates at a substantially constant reduced rate. For example, in one embodiment, the system can decelerate a 280 pound user from 1 g₀ to 0 g₀, and a speed of descent between seven and sixteen feet per second. The particular parameters and properties of the braking system can be altered as desired or as required by relevant safety regulations. With known EDDs, the individual detaches himself from the tape loop 20 at an operative position relative to a target (the “target position”), leaving the single use EDD in the unwound position, which typically requires manual re-winding and reactivation by the manufacturer.

The disclosed multi-use EDD 10 includes return assembly 18 having an energy or power unit identified generally as reference numeral 36. In a preferred embodiment, the energy unit 36 is positioned internally within the device 10. An alternate embodiment exists wherein the energy unit 36 is powered and positioned external to the device 10, for example on board the aircraft, in electrical communication with the return assembly 18. The energy unit 36 stores sufficient power to rewind the tape 17 around the spool 19 back from the extended target position to the retracted position. The energy unit 36 in the return assembly 18 may be activated automatically or by a switch mechanism to initiate rewinding of the tape 17 within the tape assembly 16. For example, in one embodiment, the return assembly 18 is configured to activate the energy unit 36 to rewind the tape at a predetermined point in time. In an alternate embodiment, the return assembly 18 will initiate retraction of the tape 17 at a predetermined length of tape extension. An additional embodiment includes a weight sensor that activates retraction when the system senses that the descending individual has removed himself from the tape loop 20. In yet additional embodiments, an individual manually activates the return system. For example, there may be an activation switch on board the aircraft for activation by an individual on-board, or an activation switch may be positioned on the device 10 proximate the loop 20 for activation by the descending individual after decent and removal of himself from the loop.

In another embodiment shown generally in FIG. 3, the energy unit 36 includes an unpowered return member, such as a spring member 38. Here, extraction of the tape 17 during descent of an individual energizes the spring mechanism 38. Once the individual releases the tape loop 20, the tape is retracted into the housing substantially via return spring force.

Once the energy system is activated, it initiates reverse rotation of the spool 19 relative to the rest of the device 10, thereby retracting the extended tape 17 into the housing. The return mechanism may advantageously include an integral breaking mechanism, similar in operation to the breaking assembly 14, for slowing the rate of return of the tape 17 via the spring bias. Once the loop 20 is returned fully to the aircraft cabin or similar initial retracted position, another user can immediately attach himself for subsequent descent. The return mechanism thus allows a single EDD 10 to be used multiple times with multiple users. Notably, the device housing 12 may be fixed to the aircraft with the tape 17 and loop 20 extending therefrom, or an end of the tape 17 may be fixed to the aircraft with the housing 12 and loop traveling with the individual during descent and then returning during retraction.

In another embodiment, the energy unit 36 stores sufficient energy to retract the tape 17 into the assembly 16 with a load attached to the free end at the loop 20, thereby returning the load to the aircraft.

The energy units discussed in the herein embodiments are non-limiting. The power source may include a battery internal to the device 10 (within the housing), connection to an on-board battery or similar power supply, or even an unpowered source such as the disclosed spring unit.

While a preferred embodiment has been set forth for purposes of illustration, the foregoing description should not be deemed a limitation of the invention herein. Accordingly, various modifications, adaptations and alternatives may occur to one skilled in the art without departing from the spirit of the invention and scope of the claimed coverage.

What is claimed is:

1. A multi-use emergency descent device for descent of a payload from an aircraft, comprising:
a tape assembly having a tape with a first end connected to a spool around which the tape is wound;
a braking assembly; and
a return assembly,
wherein the tape assembly, braking assembly and return assembly are in operative communication with each other such that the braking assembly causes deceleration of the tape being unwound from the spool during descent of a payload and the return assembly initiates retraction of the tape once activated.

2. The multi-use emergency descent device of claim 1, wherein the return assembly comprises an energy unit selected from one of the list consisting of an internal battery, external battery, electrical power supply and unpowered spring unit.

3. The multi-use emergency descent device of claim 1, wherein the return assembly is activated automatically by release of the payload from the tape to retract the tape.

4. The multi-use emergency descent device of claim 1, wherein the return assembly is activated by detection of a predetermined distance of the payload from the aircraft.

5. The multi-use emergency descent device of claim 1, wherein the return assembly is activated by a switch.

6. The multi-use emergency descent device of claim 5, wherein the switch is located proximate the payload for activation on the payload side.

7. The multi-use emergency descent device of claim 5, wherein the switch is located on board the aircraft for activation by an individual thereon.

8. The multi-use emergency descent device of claim 1, wherein the tape includes a second end attached to the aircraft and the tape assembly, braking assembly and return assembly descend with the payload.

9. The multi-use emergency descent device of claim 1, wherein the tape includes a second end with a loop for attachment of the payload, the tape assembly, braking assembly and return assembly are attached to the aircraft and the loop travels with the payload during descent.

10. A multi-use emergency descent device for descent of a payload from an aircraft, comprising:
a tape assembly having a retractable tape with a first end connected to a spool defining an axis of rotation around which the tape is wound and a terminal end attachable to a payload and reciprocable between a retracted position and an extended position;
a braking assembly operatively associated with the tape assembly for retarding the rate of unwinding of the tape from the retracted position to the extended position; and
a return assembly operatively associated with the tape assembly for rewinding the tape from the extended position to the retracted position when activated.

11. The multi-use emergency descent device of claim 10, wherein the return assembly includes an energy unit for powering retraction of the tape.

12. The multi-use emergency descent device of claim 11, wherein the energy unit is selected from at least one of the group consisting of an internal battery, external battery, electrical power supply and unpowered spring unit.

13. The multi-use emergency descent device of claim 10, wherein the return assembly is activated automatically by release of the payload from the tape to rewind the tape.

14. The multi-use emergency descent device of claim 10, wherein the return assembly is activated by detection of a predetermined distance of the payload from the aircraft.

15. The multi-use emergency descent device of claim 10, wherein the return assembly is activated by a switch.

16. The multi-use emergency descent device of claim 15, wherein the switch is located proximate the payload for activation on the payload side.

17. The multi-use emergency descent device of claim 15, wherein the switch is located on board the aircraft for activation by an individual thereon.

18. The multi-use emergency descent device of claim 10, wherein the tape terminal end with a loop for attachment of the payload, the tape assembly, braking assembly and return assembly are attached to the aircraft and the loop travels with the payload during descent.
